(19) United States
(12) Patent Application Publication
(10) Pub. No.: US 2013/0121015 A1
(43) Pub. Date: May 16, 2013

(54) Wearable Band With Variable Light Display

(71) Applicant: Ennovation Studios, LLC, North Andover, MA (US)

(72) Inventor: Enno Tjalsma, Andover, MA (US)

(73) Assignee: Ennovation Studios, LLC, North Andover, MA (US)

(21) Appl. No.: 13/678,098

(22) Filed: Nov. 15, 2012

Related U.S. Application Data
(60) Provisional application No. 61/559,961, filed on Nov. 15, 2011.

(51) Int. Cl. F21V 33/00

(52) U.S. Cl. CPC F21V 33/00
USPC 362/570

(57) ABSTRACT

Various wearable bands capable of being illuminated are disclosed. A wearable band includes a band strip defining multiple openings therein, a light source, and multiple optical fibers. Each optical fiber has a first end and a second end, with the first end of each optical fiber operably coupled to the light source. Each optical fiber is configured to transmit light originating from the light source toward the second end. Light transmitted along each optical fiber is visible through a corresponding opening of the wearable band. The openings may be arranged to form at least one letter or symbol, may be arranged along an outline of a decoration on the band strip, may be arranged to fill a region within at least one letter or symbol located on the band strip, and/or may be arranged to enhance and be conformal with a graphical design located on the band strip.

### PRIORITY CLAIM

This application claims priority under 35 U.S.C. §119(e) from U.S. Provisional Pat. App. Ser. No. 61/559,961 entitled “Illuminated Novelty Wrist Band with Variable Light Display” filed Nov. 15, 2011, which is hereby incorporated by reference herein in its entirety.

### BACKGROUND

Illuminated novelties such as buttons, fiber optic flowers, advertising displays, and clothing with internal fiber optic strands are common but are typically limited in terms of the number of lights that are viewable and/or the configuration of such lights. This invention relates to a “wrist band” herein referred to as a “band” or “wearable band” that is comfortable to wear and capable of displaying a statement or symbol.

Several patents describe the addition of fiber optic bundles into soft sewn clothing and rigid display animation used for advertising. U.S. Pat. No. 6,651,365 to Wainright teaches the addition of optical fibers on articles of clothing without bulges and detachable to allow the clothing item to be cleaned, eliminating destruction or distortion around the empty socket holes. U.S. Pat. No. 3,184,872 to Way uses a rotating opaque disk to sequentially illuminate the fibers in a pre-selected pattern. U.S. Pat. No. 5,128,843 to Guritz present the use of optical strands with flexible circuit boards to items of clothing for ornamental purposes.

### SUMMARY

In some embodiments, a wearable band includes a band strip defining a plurality of openings therein, a light source, and a light-transmissive light pipe operably coupled to the light source. The light pipe includes a plurality of molded integral light projection cylinders on a surface of the light pipe. Each cylinder has a longitudinal axis normal to a surface of the light pipe, and each cylinder is positioned to fit into a corresponding opening.

In some embodiments, a wearable band includes a band strip defining a plurality of openings therein, a light source, an encasing structure, multiple reflectors, and multiple optical fibers. The encasing structure is operably coupled to said light source. The encasing structure structure. Each cylinder has a longitudinal axis normal to the surface of the encasing structure, and each cylinder is positioned to fit into a corresponding opening. The reflectors are configured to reflect light from the light source toward respective cylinders. The optical fibers are disposed within said encasing structure, are operably coupled to the light source, and are configured to transmit the light from the light source toward respective reflectors.

In some embodiments, a wearable band includes a band strip defining multiple openings therein, a light source, and multiple optical fibers. Each optical fiber has a first end and a second end, with the first end of each optical fiber operably coupled to the light source. Each optical fiber is configured to transmit light originating from the light source toward the second end. Light transmitted along each optical fiber is visible through a corresponding opening of the wearable band.

### BRIEF DESCRIPTION OF THE DRAWINGS

The following will be apparent from elements of the figures, which are provided for illustrative purposes and are not necessarily to scale.

FIG. 1 is an illustration of an illuminated wearable band (e.g., wrist band) with decorative panel in accordance with some embodiments of the present disclosure.

FIG. 2 is an illustration of a decorative panel with light projections in accordance with some embodiments.

FIG. 3 is a plan view of the outside of a ribbon with decorative panel in accordance with some embodiments.

FIG. 4 is an enlarged inside rear view of the ribbon with light pipe and LED and circuit board in accordance with some embodiments.

FIG. 5 is an isometric view of a light pipe with light projector cylinders for edge illumination in accordance with some embodiments.

FIG. 6 is an illustration of an optical fiber bundle with LED attached thereto in accordance with some embodiments.

FIG. 7 is an inside view of a ribbon with optical bundle and circuit board in accordance with some embodiments.

FIG. 8 is an illustration of a combined optical fiber bundle and encasing structure in accordance with some embodiments.

FIG. 9 is a cross-sectional view of the apparatus shown in FIG. 8 with an encasing structure in accordance with some embodiments.

FIG. 10 is a cross-sectional view of a wearable band having a circular segment in accordance with some embodiments.

FIG. 11 is a rear plan view of optical fibers and an encasing structure, in accordance with some embodiments.

### DETAILED DESCRIPTION

This description of certain exemplary embodiments is intended to be read in connection with the accompanying drawings, which are to be considered part of the entire written description. In the description, relative terms such as “up” as well as derivatives thereof (e.g., “upward,” etc.) should be construed to refer to the orientation as then described or as shown in the drawing under discussion. These relative terms are for convenience of description and do not require that the apparatus be constructed or operated in a particular orientation.

Various embodiments of the present disclosure provide a band which may be worn for decoration, e.g., around the neck, wrist, hips, ankles, or other part of a person's body. The band may be relatively thin so as to be comfortable. For example, a piece of plastic with a thinness of about 1 mm may be formed in a ribbon and decorated on one face with a desired statement or symbol (a desired theme). The plastic may be soft and flexible for comfort and for ease of wearing and removal. Small holes may be punched through the ribbon to correspond with the statement or symbol to allow light emanating from an LED to pass out of the holes and be seen by the wearer.

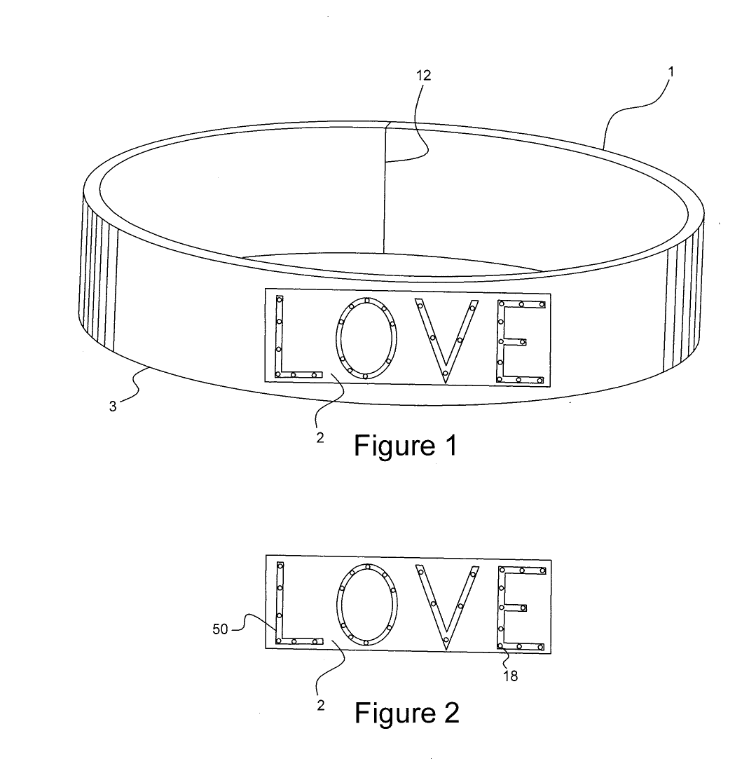

FIG. 1 is an illustration of an illuminated wrist band with decorative panel in accordance with some embodiments of the present disclosure. In FIG. 1, a band 1 includes a panel 2 that is a part of band strip 3. Respective ends of band strip 3 may be bonded together at junction 12 to form the circular band 1 as shown in FIG. 1. Alternatively, a hook and loop fastener, clasp, wristwatch-type fastener in conjunction with plural openings defined by said band strip, or any other known fastener may be provided so the user can adjust the band to the size of his/her wrist (or another body part) for desired comfort.

Referring to FIG. 2, panel 2 is decorated with an illuminated theme 50, which may include any letter, symbol and/or statement (in this example, the word “LOVE”). Theme 50 is displayed by light (which may be of any color or wavelength) emanating through holes 18 defined by the band strip 3. Any number of holes 18 may be used. In some embodiments, the holes are arranged near a decoration or design on the band strip 3, to provide illumination around the decoration or design. For example, a flower decoration on band strip 3 may be illuminated by light emanating through holes surrounding the flower. Thus, light may be visible through holes in the band strip 3 that are arranged to be conformal with the graphic design, to highlight the graphic design. The graphic design (e.g., letter(s), symbol(s), or other design) may be printed on the band strip 3, or may be effectuated by an embossing or debossing process. In some embodiments, rather than being arranged along the outline of a decoration, the holes 18 may be arranged to fill a region within a letter, symbol, or decoration.

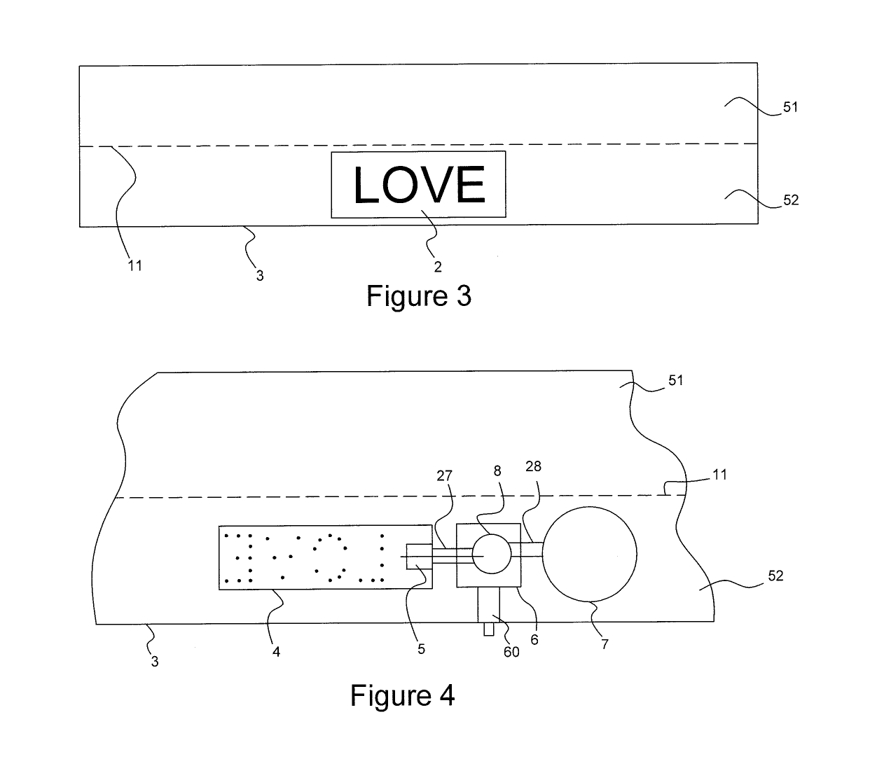

Referring to FIG. 3, band strip 3 may have the form of a ribbon including a first portion 51 and a second portion 52. The ribbon may be folded along fold line 11 (e.g., with first portion 51 folded under second portion 52) into a band having half the width of the ribbon and sealed, e.g., with an adhesive or other sealing technique. The holes 18 that allow light emanating from the LED to be seen by the wearer may be pierced in second portion 52.

The rear plan view of FIG. 4 shows the construction of band strip 3 with a light pipe 4 adjacent to and bonded to a light emitting diode (LED) 5 for optical alignment. LED 5, which may have a thickness of about 2 mm, is connected to printed circuit board 6 by wires 27 and provides a light source. An integrated circuit (IC) module 8 is attached upon circuit board 6. IC module 8 generates a pulse signal to provide continuous electricity to the LED 5. IC module 8 may control LED 5 to provide a steady (constant) lighting display and/or a pulsed (e.g., flashing) lighting display. Such an IC module 8 is readily available for controlling an LED. A battery 7 provides power to the circuit board 6 through wires 28. Battery 7 may be a thin lithium cell with a maximum thickness of about 2.4 mm in some embodiments. A switch 60 may be provided to allow the wearer to toggle the display mode between steady (constant) and pulsed (flashing) modes, and/or toggle the LED 5 between an illuminated state (“on”) and a non-illuminated state (“off”).

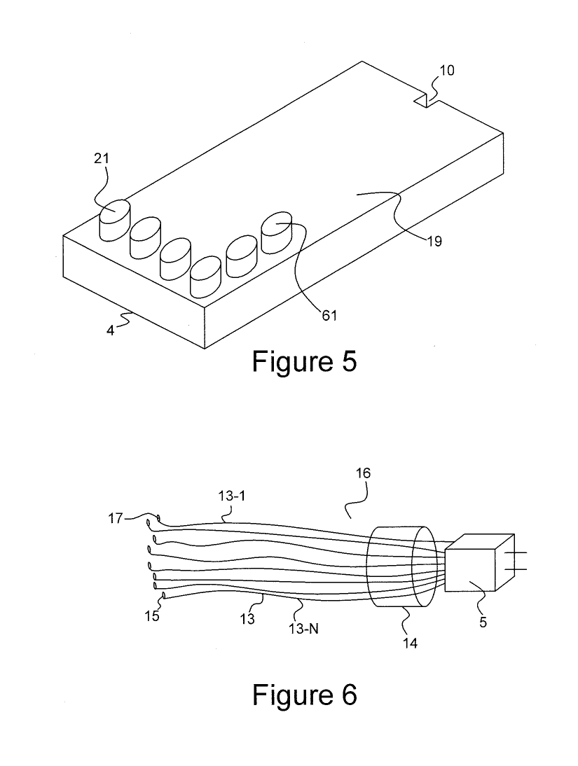

FIG. 5 is an isometric view of light pipe 4 in accordance with some embodiments. In a technique referred to as “edge illumination” LED 5 is bonded to an end of a light-transmissive light pipe 4 at an opening 10 defined by light pipe 4. LED 5 illuminates the edge of light pipe 4, which may be a physical, tangible medium for transmitting light and which may be molded from optical grade acrylic plastic. On the top surface 19 of light pipe 4 are molded integral cylinders 21 arranged in accordance with the desired theme (e.g., arranged to spell out the word “LOVE”). Each cylinder 21 has a longitudinal axis (main axis) normal to the top surface 19 of light pipe 4. Cylinders 21 may be referred to as light pipe cylinders or light projection cylinders, as light is projected through them. A top surface of cylinders 21 may have a coloring (e.g., white coloring) applied thereupon to enhance the illuminative effect. Cylinders 21 may have the same size (e.g., same diameter) as corresponding holes 18 (FIG. 2) so that each cylinder fits through a corresponding hole. Thus, light passes upwards through the cylinders 21 and is visible to the wearer.

FIG. 6 is an illustration of an optical fiber bundle 16 with LED 5 attached thereto in accordance with some embodiments. Optical fiber bundle 16 includes optical fibers 13-1, . . . , 13-N (referred to generally as “optical fibers 13”). The terminal ends of the respective optical fibers 13 are secured into a bundle by a wrapping 14 and coupled to LED 5. In some embodiments, the other ends 15 of the respective optical fibers 13 may be formed to turn at an angle of approximately 90 degrees relative to the main body of the respective fibers, so that bent ends 15 may be inserted through respective holes 18 (FIG. 2) in the band strip 3 and protrude past the holes. Different optical fibers 13 may have varying respective lengths 17 to correspond to portions of theme 50 that are at varying distances from LED 5. Thus, light emanates from LED 5 and travels to the ends of optical fibers 13, and because the bent ends 15 are inserted through respective holes 18 in panel 2 (FIG. 2), light passing upwards through holes 18 is visible to the wearer of the band. The light emanating from the optical fibers 13 may be so arranged to be conformal with a graphic design on the band, to highlight the graphical design when the ends of the fibers are illuminated.

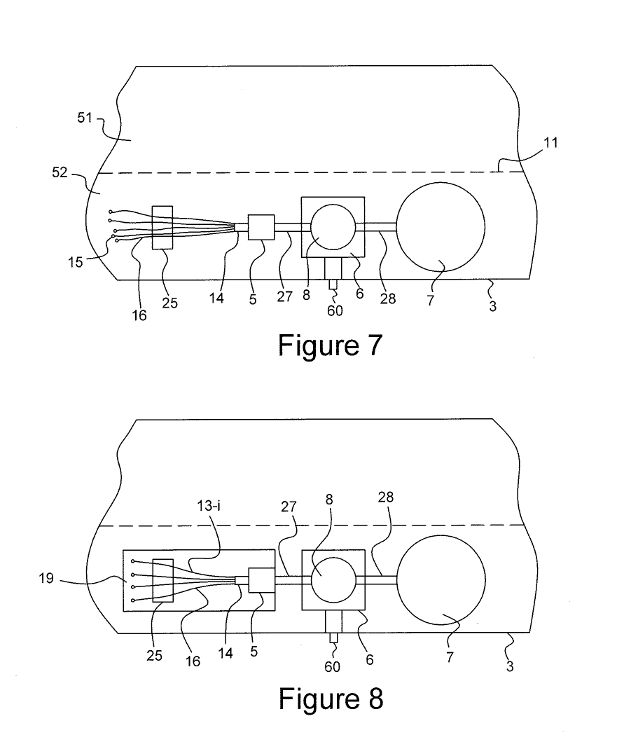

FIG. 7 is a plan view of the inside of band strip 3, e.g., before portion 51 is folded over portion 52. Bent ends 15 of respective optical fibers 13 are inserted through holes 18 in band 3. The bent ends 15 may be trimmed to have a uniform height above the outer surface of band strip 3.

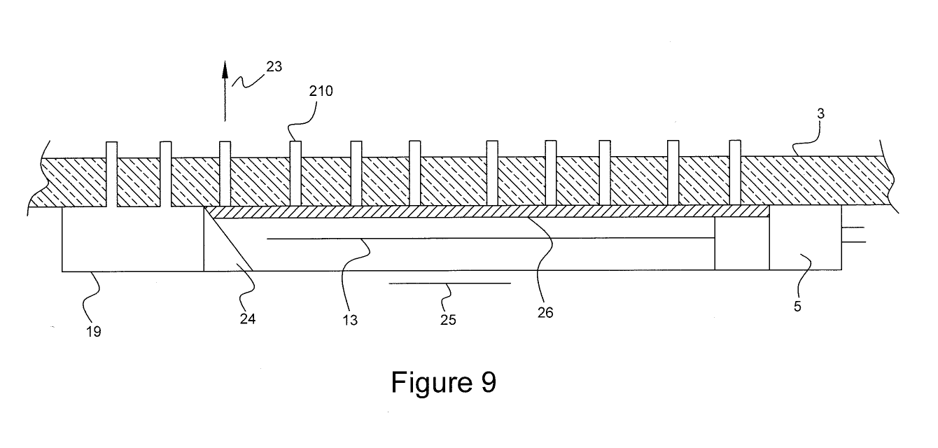

FIG. 8 is an illustration of a combined optical fiber bundle 16 and encasing structure 19 in accordance with some embodiments. Encasing structure 19 may be molded with cylinders 210 attached thereto and with optical fibers provided therein as shown in FIG. 9. Each optical fiber 13 is directed to a corresponding cylinder 210 shown in FIG. 9. The terminal end of optical fiber 13 (the end not near a corresponding cylinder 21) is in contact with LED 5. Tape 25 or adhesive may be applied to retain the optical fibers 13 in position.

FIG. 9 is a cross-sectional view of the apparatus shown in FIG. 8 with an encasing structure 19 in accordance with some embodiments in which optical fiber 13 is a straight fiber that does not have a bent end. Light 23 emitted by LED 5 is transmitted along optical fiber 13 and is directed by a reflective surface (reflector) 24 to pass upward through surface 26 and into and through cylinder 210 (along the longitudinal axis of the cylinder) for projection to the viewer. In some embodiments, encasing structure 19 is the same material as light pipe 4 shown in FIG. 5. In other embodiments, encasing structure 19 is formed from a different material than light pipe 4, and at least a portion of encasing structure 19 is light transmissive so that light exiting an end of optical fiber 13 is transmitted to reflector 24 and reflected to pass through cylinder 210 to be visible to the viewer. The fibers of bundle 16 are retained by tape 25 or with adhesive. Optical fiber 13 does not have a reflector within the optical fiber itself and does not protrude through a hole 18 in this example. Thus, optical fibers 13 in the example of FIG. 9 do not have to be trimmed to a uniform height.

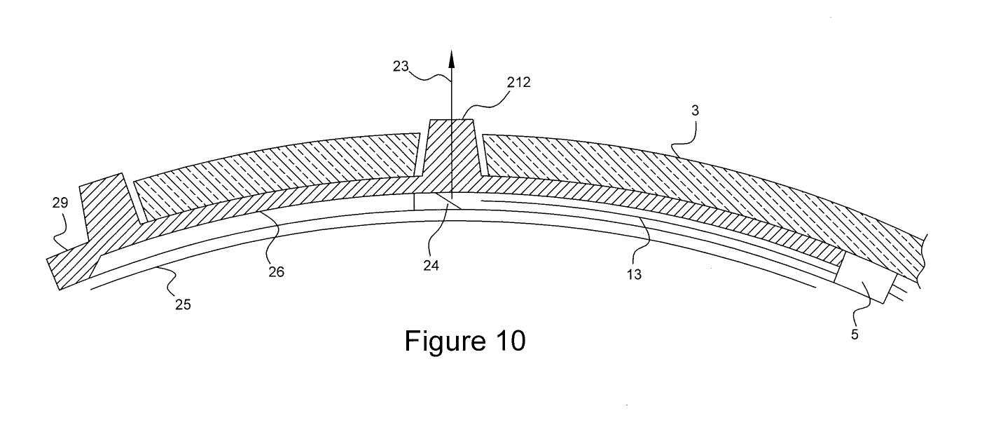

FIG. 10 is a cross-sectional view of a wearable band having a circular segment in accordance with some embodiments. The circular segment encasing structure 29 has an LED 5 attached thereto. Circular segment encasing structure 29 is similar in some respects to encasing structure 19 described in FIG. 9 but is formed in a curved shape (e.g., in the shape of a portion of a circle) that allows band strip 3 to be formed into a comfortable wrist band (or band to be worn on another part of the body) with no flat surfaces. Light passes within optical fiber 13 to a reflective surface 24 and is projected upwards 23 via cylinder 212 to the viewer. By molding the encasing structure 29 into a curved shape conforming to the desired diameter of the band, a uniform circular form factor is created.

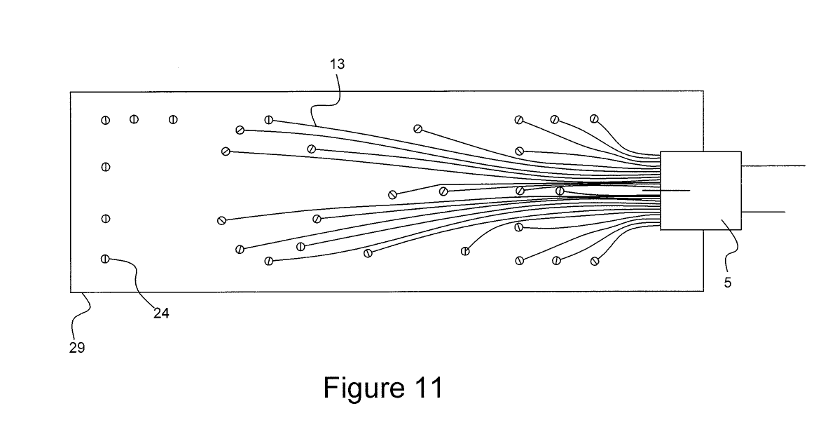

FIG. 11 is a rear plan view of optical fibers and an encasing structure as in FIG. 10, in accordance with some embodiments. In FIG .11, the individual optical fiber 13 is shown in juxtaposition to reflective surface 24, which directs light through top surface 26 and through cylinder 212.

While examples of various embodiments have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A wearable band comprising:
a band strip defining a plurality of openings therein;
a light source;
a light-transmissive light pipe operably coupled to said light source, said light pipe including a plurality of molded integral light projection cylinders on a surface of said light pipe, each cylinder having a longitudinal axis normal to a surface of said light pipe, each cylinder positioned to fit into a corresponding opening.

2. The wearable band of claim 1, wherein said light pipe comprises optical grade acrylic plastic.

3. The wearable band of claim 1, wherein a top surface of each cylinder include a coloring applied thereupon, said coloring configured to enhance visibility when the cylinder is illuminated.

4. The wearable band of claim 1, wherein said band strip includes having a first end and a second end, said band strip is formed from a flexible material, and said first end is configured to be secured to a portion of said band strip at or near said second end to form a loop.

5. The wearable band of claim 1, wherein said openings are arranged to form at least one letter or symbol.

6. The wearable band of claim 1, wherein said openings are arranged along an outline of a decoration on said band strip.

7. The wearable band of claim 1, wherein said openings are arranged to fill a region within at least one letter or symbol located on said band strip.

8. The wearable band of claim 1, wherein said openings are arranged to enhance and be conformal with a graphical design located on said band strip.

9. The wearable band of claim 8, wherein said graphical design is produced on said band strip by one of a printing, embossing, and debossing process.

10. The wearable band of claim 1, wherein said light source is operably coupled to said light pipe at an opening defined at an end of said light pipe.

11. The wearable band of claim 1, wherein said light source includes a light emitting diode, said band further comprising:
a power supply; and
a control circuit operably coupled to said power supply and to said light emitting diode, wherein said control circuit is configured to control said light emitting diode to selectively emit light.

12. The wearable band of claim 11, further comprising a switch configured to toggle a display mode of said light source between a constant emission mode and a pulsed emission mode.

13. The wearable band of claim 11, further comprising a switch configured to toggle a state of said light source between an on state and an off state.

14. The wearable band of claim 1, wherein said band strip includes a first band strip portion folded over a second band strip portion to enclose said light source and said light pipe between said first and second band strip portions.

15. A wearable band comprising:
a band strip defining a plurality of openings therein;
a light source;
an encasing structure operably coupled to said light source, said encasing structure including a plurality of molded integral light projection cylinders on a surface of said encasing structure, each cylinder having a longitudinal axis normal to said surface of said encasing structure, each cylinder positioned to fit into a corresponding opening;
a plurality of reflectors configured to reflect light from said light source toward respective cylinders; and
a plurality of optical fibers within said encasing structure, said optical fibers operably coupled to said light source and configured to transmit the light from said light source toward respective reflectors.

16. The wearable band of claim 15, further comprising an adhesive configured to secure a position of each optical fiber.

17. The wearable band of claim 15, wherein said openings are arranged to form at least one letter or symbol.

18. The wearable band of claim 15, wherein said openings are arranged along an outline of a decoration on said band strip.

19. The wearable band of claim 15, wherein said openings are arranged to fill a region within at least one letter or symbol located on said band strip.

20. The wearable band of claim 15, wherein an illuminated end of each optical fiber is arranged to enhance and be conformal with a graphical design located on said band strip.

21. The wearable band of claim 15, wherein said encasing structure includes a curved segment.

22. A wearable band comprising:
a band strip defining a plurality of openings therein;
a light source; and
a plurality of optical fibers, each optical fiber having a first end and a second end, the first end of each optical fiber operably coupled to said light source, each optical fiber configured to transmit light originating from said light source toward said second end, wherein light transmitted along each optical fiber is visible through a corresponding opening.

23. The wearable band of claim 22, wherein each optical fiber includes a bent portion at said second end, said bent portion configured to pass through a corresponding opening.

24. The wearable band of claim 23, wherein the second ends of said optical fibers are trimmed to a uniform height above said openings.

25. The wearable band of claim 22, wherein said openings are arranged to form at least one letter or symbol.

26. The wearable band of claim 22, wherein said openings are arranged along an outline of a decoration on said band strip.

27. The wearable band of claim 22, wherein said openings are arranged to fill a region within at least one letter or symbol located on said band strip.

28. The wearable band of claim 22, wherein an illuminated end of each optical fiber is arranged to enhance and be conformal with a graphical design located on said band strip.

29. The wearable band of claim 22, wherein said light source includes a light emitting diode, said band further comprising:
a power supply; and
a control circuit operably coupled to said power supply and to said light emitting diode, wherein said control circuit is configured to control said light emitting diode to selectively emit light.
